(19) United States
(12) Patent Application Publication
(10) Pub. No.: US 2025/0236686 A1
(43) Pub. Date: Jul. 24, 2025

(54) HYDROGEL CHITOSAN FROM SHRIMPS SHELLS FOR BIOFILTER SYSTEM

(71) Applicant: QATAR UNIVERSITY, Doha (QA)

(72) Inventors: Anis DAOU, Doha (QA); Jana AYACH, Beirut (LB); Akram HIJAZI, Beirut (LB); Luminita DUMA, Reims (FR); Mohamad MEDLEJ, Beirut (LB); Hussein HAMAD, Beirut (LB)

(21) Appl. No.: 19/174,566

(22) Filed: Apr. 9, 2025

Related U.S. Application Data
(63) Continuation of application No. 18/133,286, filed on Apr. 11, 2023.
(60) Provisional application No. 63/329,631, filed on Apr. 11, 2022.

(51) Int. Cl. C08B 37/08; B01D 46/00

(52) U.S. Cl. CPC C08B 37/003; B01D 46/0001

(57) ABSTRACT

Described herein is a naturally produced hydrogel chitosan layer made from shrimp shells for a biofilter system and a method of producing the hydrogel chitosan layer comprising extracting the chitosan from the shrimp shells.

### CROSS-REFERENCE TO RELATED APPLICATIONS

This application claims priority to and the benefit of U.S. Provisional Patent Application No. 63/329,631 filed Apr. 11, 2022, the entire contents of which are herein incorporated in their entirety for all purposes.

### TECHNICAL FIELD

Described herein is a naturally produced hydrogel chitosan layer made from shrimp shells for a biofilter system and a method of producing the hydrogel chitosan layer comprising extracting the chitosan from the shrimp shells.

### BACKGROUND OF THE INVENTION

Recently the level of environmental pollution, especially the pollution of seawater, has increased dramatically. Seawater pollution includes organic pollutants (metals: Cd, Pb, Cul), inorganic pollutants (dyes: methylene blue (MB), violet crystal (CV)), bacteria (Streptococcus D. Staphylococcus aureus), and viruses (Coronaviridae).

Exacerbating the problem of high pollution is the high price of water cleaning techniques. Furthermore, certain traditional techniques require high amounts of energy, which in turn leads to more pollution.

For this reason, new green technology and solutions are needed to mitigate seawater pollution. For example, in rural areas, sewage for the irrigation of crops can be filtered and recycled. One method to recycle water in the city includes the desalination of seawater and groundwater to make the water more suitable for domestic use and drinking. Additionally, it would be more environmentally friendly to clean swimming pool water through a recyclable filter instead of a plastic filter.

Therefore, what is needed are new sustainable biofilters that not only require minimal energy to filter water, but also minimal resources and energy to produce.

### SUMMARY OF THE INVENTION

Provided herein a hydrogel chitosan layer naturally produced from shrimp shells for a biofilter system. Also provided herein is a biofilter for water filtration wherein one of the layers is the hydrogel made from naturally produced chitosan. The chitosan layer adsorbs metals, dyes, and bacterial wastes, which are then eliminated. As described herein, the chitosan is extracted by demineralization, deproteinization, deacetylation and decolorization from shrimp shells. Once extracted, chitosan is then combined with a natural cross linker to afford a hydrogel. In one embodiment, the cross linker is glutaraldehyde. In one embodiment, the cross linker is genipen. In an alternative embodiment, the hydrogel chitosan layer further comprises at least one essential oil or extract from the Lamiaceae family, such as, for example rosemary oil or extract, eucalyptus oil or extract, thyme oil or extract, a citrus (such as, an Orange) oil or extract, or a botanical berry (such as, a Banana) oil or extract. In one embodiment, the biofilter further comprises a banana stem or an orange peel. In one embodiment, the biofilter further comprises a banana stem or an orange peel.

As described herein in certain embodiments, the chitosan extracted from shrimp shells as described herein is a natural, eco-friendly filter that eliminates hard water (Ca, Mg), heavy metals, organic pollutants, inorganic pollutants, bacteria, and/or viruses very effectively. Compared to expensive water-cleaning technology that requires high amounts of energy, the filters described herein are inexpensive and require minimal energy to operate. They also produce no waste and are 100% recyclable.

Chitosan is non-toxic and odorless. Furthermore, commercial chitosan is approximately €86 for 25 g, while the extraction of 100 g of artificial chitosan from shrimp shells costs only about €20. Therefore, in another aspect, described herein is a process of producing the chitosan hydrogel described herein by extracting adsorbent chitosan from shrimp shells wherein the process comprises demineralization, deproteinization, deacetylation and decolorization and then crosslinking the chitosan with a natural crosslinker to form the hydrogel. In one embodiment, the cross linker is glutaraldehyde. In one embodiment, the cross linker is genipen.

Also described herein is a process wherein the chitosan extracted from shrimp shells is used to prepare a macroporus membrane. Chitosan is mixed with silica particles and following an initial drying step to evaporate excess solution, the dried membrane is immersed in NaOH solution with heat to dissolve the silica particles and generate a porous membrane. To prevent shrinking, the porous membrane is immersed in a softening agent to afford a flexible macroporus membrane. In alternative embodiments, the biofilter for water filtration is a biofilter wherein one of the layers is the macroporus chitosan membrane.

### BRIEF DESCRIPTION OF DRAWINGS

FIG. 1 is a graph showing the percent of copper removed from the synthesized chitosan as the contact time increases.

FIG. 2 is a graph of the percent of lead removed from the synthesized chitosan as the contact time increases.

FIG. 3 is an FTIR spectrum of synthesized chitosan.

FIG. 4 is an FTIR spectrum of commercial chitosan.

FIG. 5 is a size analysis of synthesized chitosan.

FIG. 6 is a size analysis of commercial chitosan.

### DETAILED DESCRIPTION OF THE INVENTION

Described herein is a process for the formation of a chitosan hydrogel wherein the chitosan is extracted from shrimp shells comprising the following steps:
a. a demineralization step wherein ground shrimp shells are immersed in an acid and stirred followed by neutralization, filtering, and drying to afford demineralized shells;
b. a deproteinization step wherein the demineralized shells are stirred and heated with an alkaline solution followed by neutralization, filtering, and drying to afford deproteinized chitin;
c. a deacetylation step wherein the deproteinized chitin is stirred and heated with sodium hydroxide followed by neutralization, filtering, and drying to afford deacetylated chitosan; and
d. a decolorization step wherein the deacetylated chitosan is treated with hydrogen peroxide for at least about 1 hour followed by filtering and rinsing to afford chitosan powder;
e. a chitosan ball formation step wherein the chitosan powder is mixed with an acid, centrifuged, and injected dropwise into a sodium hydroxide solution to form beads that are then placed in a sodium hydroxide solution for at least about 1 hour, filtered, and rinsed to afford chitosan balls; and
f. a hydrogel formation step wherein the chitosan balls are reacted with a natural cross linker to form the chitosan hydrogel.

In one embodiment, the acid of step (a) is hydrochloric acid. In one embodiment, the ratio of shrimp shells to hydrochloric acid in step (a) is about 1:6 (w/v). In one embodiment, the shrimp shells are stirred in the acid in step (a) for about 12 hours, about 16 hours, about 20 hours, about 24 hours, or about 28 hours. In one embodiment, the shrimp shells are stirred in the acid for about 24 hours. In one embodiment, the solution is neutralized in step (a) with sodium hydroxide until the pH is about 7 or 7.5. In one embodiment, the filtered material in step (a) is dried at about 60° C. for at least for about 12 hours, about 16 hours, about 20 hours, about 24 hours, or about 28 hours.

In one embodiment, the alkaline solution of step (b) is sodium hydroxide. In one embodiment, the ratio of the shells to sodium hydroxide in step (b) is about 3:40 (w/v). In one embodiment, the demineralized shells in step (b) are heated with the alkaline solution at about 80° C., 85° C., 90° C., 95° C., 100° C., 105° C., or 110° C. for at least about 15 minutes, at least about 20 minutes, at least about 30 minutes, or at least about 45 minutes. In one embodiment, the demineralized shells are heated with the alkaline solution at about 100° C. for at least about 30 minutes. In one embodiment, the solution is neutralized in step (b) with ortho-phosphoric acid until the pH is about 7 or 7.5. In one embodiment, the filtered material in step (b) is dried at about 60° C. for at least for about 12 hours, about 16 hours, about 20 hours, about 24 hours, or about 28 hours.

In one embodiment, in step (c), the deproteinized chitin are heated with the sodium hydroxide at about 120° C., 125° C., 130° C., 135° C., 140° C., 145° C., or 150° C. for at least about 1 hour, at least about 2 hours, at least about 3 hours, or at least about 4 hours. In one embodiment, the neutralization of step (c) is done with ortho-phosphoric acid until the pH is about 7 or 7.5. In one embodiment, the filtered material in step (c) is dried at about 60° C. for at least for about 12 hours, about 16 hours, about 20 hours, about 24 hours, or about 28 hours.

In one embodiment, the treatment with hydrogen peroxide in step (d) is for at least 3 hours. In one embodiment, the ratio of deacetylated chitosan to hydrogen peroxide in step (d) is about 1:10 (w/v). In one embodiment, the rinsing in step (d) is done with distilled water. In one embodiment, the filtered material in step (d) is dried at about 60° C. for at least for about 1 hour, about 2 hours, about 3 hours, or about 4 hours.

In one embodiment, the acid of step (e) is acetic acid and the pH is between about 3 and 4. In one embodiment, In step (e), the beads are placed in a sodium hydroxide solution at about 25-35° C. for about 3 hours, about 4 hours, about 6 hours, or about 8 hours. In one embodiment, in step (e), the beads are filtered and rinsed with ethanol/water solutions. In one embodiment, the ethanol/water ratio is about 1:9, about 3:7, about 5:5, about 9:10, or about 1:0.

In one embodiment, the cross linker in step (f) is glutaraldehyde. In one embodiment, the cross linker in step (f) is genipen.

In an alternative process, the chitosan powder of step (d) or the chitosan balls of step (e) are used to produce a silica-based chitosan macroporous membrane wherein the chitosan powder of step (d) or the chitosan balls of step (e) are dissolved in an acid and mixed with silica particles. Following a drying step to allow excess liquid to evaporate, the dried membrane is immersed in a NaOH solution with heating to afford a porous membrane. Lastly, the membrane is immersed in a softening agent to afford a flexible macroporous chitosan membrane.

In one embodiment, the acid used to dissolve the chitosan powder of step (d) or the chitosan balls of step (e) is acetic acid. In one embodiment, the dried membrane is immersed in a NaOH solution for at least 2 hours at about 75° C., 80° C., 85° C., 90° C., 95° C., or 100° C. In one embodiment, the NaOH solution is a 5 wt % aqueous NaOH solution. In one embodiment, the softening agent is an aqueous glycerol solution. In one embodiment, the membrane is immersed in the softening agent for no more than about 15, 25, 30, 40, 45, 50, or 60 minutes.

In an alternative embodiment, the process comprises an additional step of adding at least one essential oil or extract, for example rosemary oil or extract, eucalyptus oil or extract, thyme oil or extract, or a citrus (banana or orange) oil or extract to the chitosan hydrogel.

Also described herein are chitosan gel balls prepared by steps (a)-(e) as described herein. Also described herein is a chitosan hydrogel prepared by a process described herein. In an alternative embodiment, the hydrogel chitosan layer further comprises at least one essential oil or extract, for example rosemary oil or extract, eucalyptus oil or extract, thyme oil or extract, or a citrus (banana or orange) oil or extract.

In certain embodiments, the chitosan of the hydrogel or the chitosan ball eliminates hard water, heavy metal, organic pollutants, inorganic pollutants, bacteria and/or viruses effectively and in a short amount of time. In one embodiment, the chitosan of the hydrogel or the chitosan ball eliminates heavy metals, for example copper and/or lead. For example, in one embodiment, the chitosan of the hydrogel or the chitosan ball removes at least 90% of copper filtered through the chitosan in about 360 minutes. In one embodiment, the chitosan of the hydrogel or the chitosan ball removes at least 92%, 95%, 97%, or 98% of copper filtered through the chitosan in about 360 minutes. In one embodiment, the chitosan of the hydrogel or the chitosan ball removes at least 90% of lead filtered through the chitosan in about 60 minutes. In one embodiment, the chitosan of the hydrogel or the chitosan ball removes at least 92%, 95%, 97%, or 98% of lead filtered through the chitosan in about 60 minutes.

In one embodiment, the chitosan of the hydrogel or the chitosan ball eliminates inorganic pollutants, for example dyes, such as methylene blue and/or violet crystal.

In one embodiment, the chitosan of the hydrogel is characterized by the FTIR spectrum of FIG. 3. In one embodiment, the chitosan of the hydrogel is characterized by an FTIR spectrum with peaks at about 3418 cm⁻¹, about 1155 cm⁻¹, about 1076 cm⁻¹, and 618 cm⁻¹, and absorption peaks at about 2922 cm⁻¹ and 1639 cm⁻¹.

In one embodiment, the chitosan of the hydrogel is characterized by an average particle size between about 250,000 μm and 260,000 μm. In one embodiment, the chitosan of the hydrogel is characterized by an average particle size of about 255,000 μm. In one embodiment, the chitosan of the hydrogel is characterized by an average particle size of about 255,615 μm.

Also described herein is a biofilter comprising the chitosan hydrogen prepared as described herein. In certain embodiments, the biofilter further comprises natural materials, including, but not limited to, rosemary, banana stems or orange peels. In one embodiment, the biofilter comprises at least two layers wherein one layer comprises the hydrogel chitosan layer produced as described herein and the second layer comprises a banana stem or orange peel. In certain embodiments, the biofilter or the hydrogel chitosan layer further comprises rosemary.

In one embodiment, the biofilter comprises at least two layers wherein one layer of the biofilter comprises the hydrogel chitosan layer produced as described herein and rosemary and the second layer comprises a banana stem or orange peel. In one embodiment, the biofilter comprises at least two layers wherein one layer of the biofilter comprises the hydrogel chitosan layer produced as described herein and the second layer comprises rosemary and a banana stem or orange peel. In one embodiment, the biofilter comprises three layers wherein one layer comprises the hydrogel chitosan layer produced as described herein, a second layer comprises rosemary, and a third layer comprises a banana stem or orange peel.

### EXAMPLE 1. CHITOSAN PREPARATION

The shrimp shells used in this study to extract chitosan were from a fishery on Sidon Beach. The shrimp were carefully shelled, washed several times with tap water to remove all possible impurities (salts, sands, shells, etc.), rinsed with distilled water, and frozen at a temperature −70° C. Once the shells of the shrimp become icy, they were placed in a Lyoph where they were passed from the solid state to a gaseous state directly (sublimation). Finally, they were crushed into fine powder in a grinder to obtain particles of size<1 mm.

### The Chitosan Extraction Steps

Demineralization: The ground shrimp shells (1 g) were immersed in 6 mL of an aqueous solution of hydrochloric acid HCl (5% HCl). This process can be scaled up or down at the ratio of shrimp:HCl of 1:6 (w/v). The solution was stirred for 24 hours at room temperature. After 24 hours of stirring, the solution was neutralized with sodium hydroxide (NaOH) until the pH reached 7. A filtration was done after and the resulting material was placed in the oven at a temperature of 60° C. for 24 hours.

Deproteinization: The demineralized shells (3 g) were subjected to alkaline treatment with 2N NaOH (40 mL). This process can be scaled up or down with the ratio of shells:NaOH of 3:40 (w/v). Once the temperature of the alkaline solution was 100° C., the demineralized material was added and the solution was stirred for 30 minutes. At the end of the stirring, the solution was neutralized by ortho-phosphoric acid until the pH reached 7. After neutralization, the solution was filtered and the resulting material was introduced into the oven at a temperature of 60° C. until it was completely dried. After this step, chitin was formed.

Deacetylation: A solution of 12.5M NaOH (10 mL) was heated to 140° C. and deproteinized chitin (1 g) was introduced with continuous stirring for 4 hours. When the stirring was complete, the solution was neutralized by ortho-phosphoric acid until the pH reached 7. The solution was filtered and placed in the oven at a temperature 60° C. overnight.

Decolorization: Chitosan (1 g) obtained by deacetylation was treated with 5% hydrogen peroxide (H₂O₂). The process can be scaled up or down with the ratio of chitosan:H₂O₂ of 1:10 (w/v) with magnetic stirring for 1-3 hours. Once the color no longer persisted, the solution was filtered with Büchner funnel and rinsed with distilled water to remove any trace of hydrogen peroxide. The chitosan powder obtained was dried in the oven for a few hours.

Formation of chitosan balls: Chitosan powder was converted into gel balls. The beads were formed by mixing 1g of commercial chitosan with 100mL of 5% acetic acid at pH of about 4. The mixture was introduced into a centrifuge to remove any air bubbles. The solution was then injected dropwise into an NaOH solution (3M) using a syringe. The resulting beads were placed in NaOH solution at a temperature of 25° C. for 6 hours. They were then filtered and rinsed with ethanol/water solutions according to the following ratios: 1:9, 3:7, 5:5, 9:10, and 1:0.

### EXAMPLE 2. ADSORPTION OF CHITOSAN

Atomic Absorption Spectroscopy (AAS): Atomic absorption spectroscopy (AAS) and atomic emission spectroscopy (AES) is a spectro-analytical procedure for the quantitative determination of chemical elements using the absorption of optical radiation (light) by free atoms in the gaseous state. Atomic absorption spectroscopy is based on absorption of light by free metallic ions. In analytical chemistry, the technique is used for determining the concentration of a particular element (the analyte) in a sample to be analyzed.

Preparation of adsorbates (metals): Batch experiments were carried out to determine the optimum sorption of copper and lead metals by the synthesized chitosan balls at different times of contact, pHs and temperatures.

A solution of lead (10 mg lead/1L) and copper (2.5 mg copper/1L) were prepared. Both solutions were prepared from standard solutions (1000 μg/ml). Different pH values (2.8 and 7 (using solutions of NaOH and HCl)), times of contact (10, 30 and 60 minutes) and temperatures (25, 45 and 65° C.) were studied. For each sample, 0.1 g of synthesized chitosan was mixed with 50 mL of the mother solution and the sorption was enhanced by a shaker. The samples were then filtered by a syringe and measured with atomic absorption spectroscopy (AAS).

The pH parameter was optimized at room temperature (25° C.) with 10 minutes as the time of contact. The time of contact was optimized at room temperature (25° C.) and normal pH of the solution (2.8). Finally, the temperature parameter was adjusted at normal pH of the solution (2.8) and 10 minutes as the time of contact. These experiments were performed with both lead and copper solution. In an additional experiment, the pH was fixed at 5.5, the contact time was optimized at the fixed temperature of 25° C., and the temperature was optimized at the fixed contact time of 30 minutes. Table 1 provides the conditions for each experiment.

TABLE 1
Temperature, pH, and Time of
Contact Parameters

| | | Time of |
|---|---|---|
| Temperature | pH | Contact |
| 25° C. | 2.8 | 10 min |
| 25° C. | 7 | 10 min |
| 25° C. | 2.8 | 30 min |
| 25° C. | 2.8 | 60 min |
| 45° C. | 2.8 | 10 min |
| 65° C. | 2.8 | 10 min |
| 25° C. | 5.5 | 30 min |

### Preparation of Adsorbates (Dyes):

Methylene blue (MB): A stock solution with a concentration of 1 g/L was prepared by dissolving the MB powder in ultra-pure water in a volumetric flask and the daughter solutions were obtained by diluting this stock solution.

Crystallized violet (CV): A stock solution of 250 mg/L concentration was prepared by dissolving the VC powder in ultra-pure water in a volumetric flask and the daughter solutions were obtained by diluting this stock solution.

### Adsorption Methods

The adsorption experiments were carried out following a series of experiments to study the effect of different parameters on adsorption such as the effect of initial concentration, effect of pH, effect of contact time, and effect of temperature on the absorption of dyes contained in solutions. All adsorption experiments were performed at a temperature of 25±2° C., except where the effect of temperature was studied.

### EXAMPLE 3. THE EFFECT OF CONTACT TIME ON THE REMOVAL OF COPPER

To optimize the adsorption performance of pollutants (metals or dyes) on chitosan, a 0.1g mass of chitosan powder was mixed with 100 mL of the BM solution (a concentration of 10 mg/L) at different contact times (10, 30, 60 and 120 minutes) and stirred at a temperature of 25±2° C. After each time interval, samples were taken through a syringe fitted with a 0.45 μm pore size filter and analyzed by atomic absorption spectrophotometry.

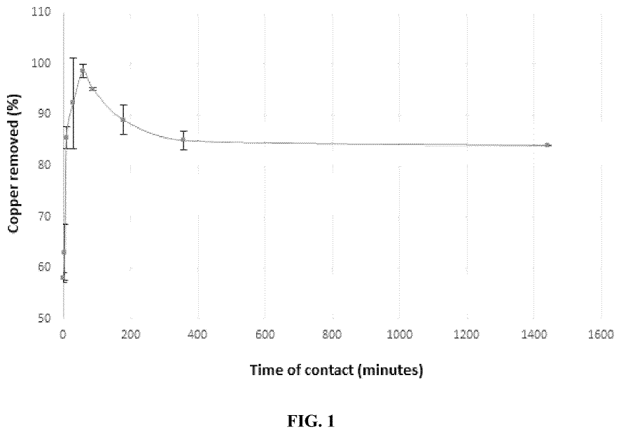

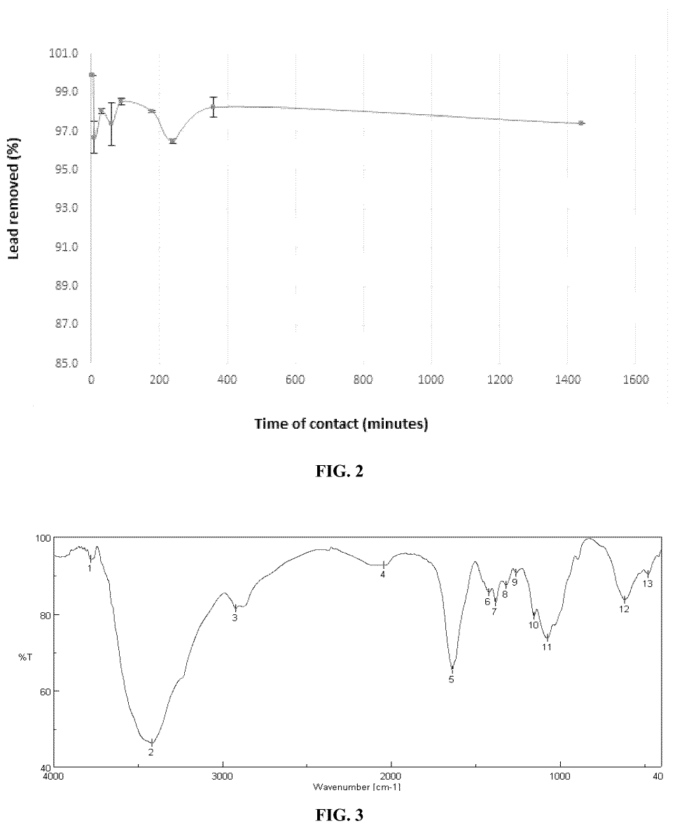

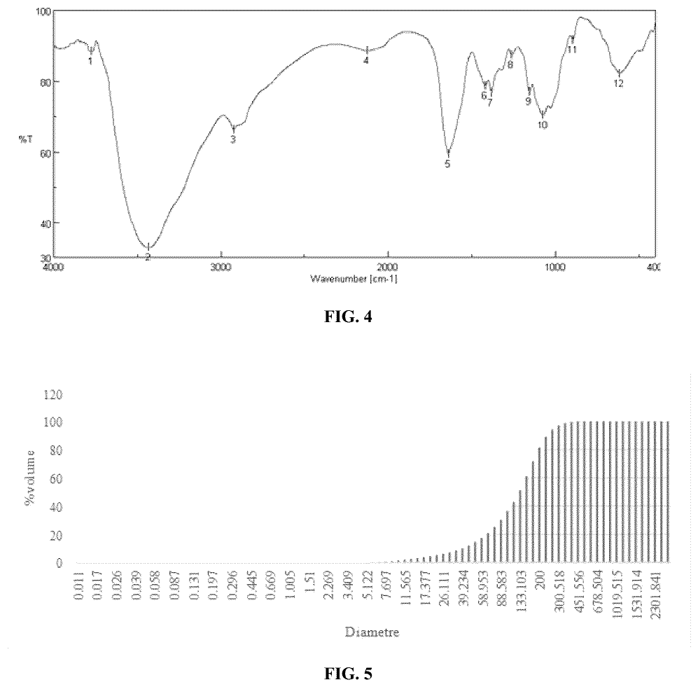

To study the effect of contact time on the removal of metals from synthesized chitosan, the chitosan and metal samples were shaken together using a shaker for 1, 5, 10, 30, 60, 90, 180, 360 and 1440 minutes. This was done at a pH of 5 and at room temperature (25° C.). As shown in FIG. 1, the maximum removal of copper (98.554%) from the solution was achieved at 360 minutes (6h) of contact with chitosan. The removal of lead is shown in FIG. 2. The maximum removal of lead (99%) was achieved in 60 minutes.

### EXAMPLE 4. CHARACTERIZATION OF SYNTHESIZED CHITOSAN POWDER

The analysis of the synthesized chitosan was done by FTIR Fourier transform infrared spectroscopy.

The FTIR spectra have characteristic bands. As shown in FIG. 3, the spectra for the synthesized chitosan have a peak at 3418.21 cm⁻¹, indicating symmetric stretching vibration of O—H and amine. An absorption peak at 2922.59 cm⁻¹ indicates the presence of C—H stretch, an absorption band at 1639.2 is due to C═O stretching (amide I), and peaks at 1155.15 and 1076.08 cm⁻¹ are for C—O stretching. A characteristic bond for β-1-4 glycosidic linkage is a peak at 618.074 cm⁻¹.

Commercial chitosan generally has the same stretching vibrations compared to synthesized chitosan, but with unimportant or slight shifting.

### EXAMPLE 5: GRANULOMETRY

A particle size study was conducted to determine the statistical size distribution of a collection of finite elements of natural or fractional material. The shells of the shrimp were crushed using a grinder to have them in particle size of 1 mm, the powder obtained was subjected to a particle size analysis by Dynamic Laser Particle Size. Both synthesized and commercial chitosan were studied.

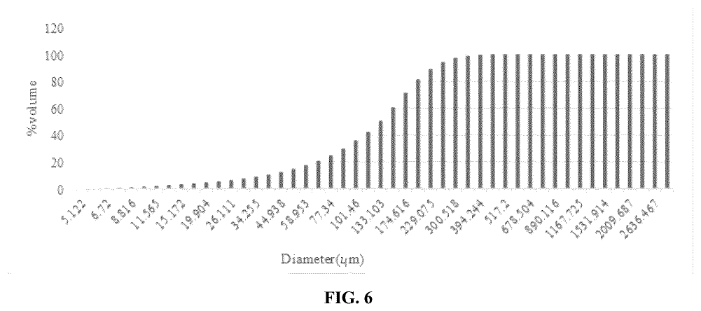

A spectrum for the synthesized chitosan is shown in FIG. 5. There was a homogeneous particle distribution and a population was obtained at 1754.613 μm. The general average particle diameter was 255,615 μm. FIG. 6 is the spectrum for commercial chitosan. There was a homogeneous particle distribution and a population was obtained at 451,566 μm. The general average particle diameter was 255,615 μm.

Comparing the results, the average diameter for both commercial and synthesized chitosan was the same at 255,615 μm. Based on the particle size, an important factor in adsorption, the chitosan described herein from shrimp shells are as effective as commercial chitosan.

### EXAMPLE 6. SYNTHESIS OF CHITOSAN MACROPOROUS MEMBRANE

The chitosan macroporous membranes were prepared as follows: a solution of chitosan was first obtained by dissolving 1 g of chitosan in 100 mL of 1 vol % aqueous acetic acid solution. To this solution, silica particles were added, followed by vigorous stirring in order to disperse them uniformly. Then, the solution was poured onto a rimmed glass plate and the liquid allowed to evaporate. The dried membrane was immersed in a 5 wt % aqueous NaOH solution and kept for 2 h at 80° C. in order to dissolve the silica particles and to generate a porous membrane. The heat treatment accelerated the dissolution of silica and also improved the mechanical properties of the membrane. Finally, the porous membrane was washed with distilled water to remove the remaining NaOH. In order to prevent its shrinkage during drying, the membrane was immersed in a 20 vol % aqueous glycerol solution (softening agent) for 30 min and, after the excess glycerol solution was removed, placed on a glass plate and allowed to dry. Thus, a strong and flexible macroporous chitosan membrane without shrinkage was obtained.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

1. A process for the formation of a chitosan hydrogel wherein the chitosan is extracted from shrimp shells comprising the following steps:
a. a demineralization step wherein ground shrimp shells are immersed in an acid and stirred followed by neutralization, filtering, and drying to afford demineralized shells;
b. a deproteinization step wherein the demineralized shells are stirred and heated with an alkaline solution followed by neutralization, filtering, and drying to afford deproteinized chitin;
c. a deacetylation step wherein the deproteinized chitin is stirred and heated with sodium hydroxide followed by neutralization, filtering, and drying to afford deacetylated chitosan; and
d. a decolorization step wherein the deacetylated chitosan is treated with hydrogen peroxide for at least about 1 hour followed by filtering and rinsing to afford chitosan powder;
e. a chitosan ball formation step wherein the chitosan powder is mixed with an acid, centrifuged, and injected dropwise into a sodium hydroxide solution to form beads that are then placed in a sodium hydroxide solution for at least about 1 hour, filtered, and rinsed to afford chitosan balls; and
f. a hydrogel formation step wherein the chitosan balls are reacted with a natural cross linker to form the chitosan hydrogel.

2. The process of claim 1, wherein the acid of step (a) is hydrochloric acid.

3. The process of claim 2, wherein the ratio of shrimp shells to hydrochloric acid is about 1:6 (w/v).

4. The process of claim 1, wherein the alkaline solution of step (b) is sodium hydroxide.

5. The process of claim 4, wherein the ratio of the shells to sodium hydroxide is about 3:40 (w/v).

6. The process of claim 1, wherein the demineralized shells are stirred and heated to about 100° C. with the alkaline solution in step (b).

7. The process of claim 1, wherein the deproteinized chitin is stirred and heated to about 140° C. with sodium hydroxide in step (c).

8. The process of claim 1, wherein the neutralization of step (c) is done with ortho-phosphoric acid.

9. The process of claim 1, wherein the treatment with hydrogen peroxide in step (d) is for at least 3 hours.

10. The process of claim 7, wherein the ratio of deacetylated chitosan to hydrogen peroxide is about 1:10 (w/v).

11. The process of claim 1, wherein the acid of step (e) is acetic acid.

12. The process of claim 1, wherein the cross linker in step (f) is glutaraldehyde.

13. The process of claim 1, wherein the cross linker in step (f) is genipen.

14. The process of claim 1, wherein the beads are placed in a sodium hydroxide solution for at least about 4 hours.

15-20. (canceled)
